(19) United States
(12) Patent Application Publication
(10) Pub. No.: US 2018/0087499 A1
(43) Pub. Date: Mar. 29, 2018

(54) SYSTEM FOR DETECTING FAULTS IN A PUMP

(71) Applicant: Caterpillar Inc., Peoria, IL (US)

(72) Inventors: Yanchai Zhang, Dunlap, IL (US); Venkata Bhagavathi Dandibhotla, Peoria, IL (US); Zhijun Cai, Springfield, IL (US)

(73) Assignee: Caterpillar Inc., Peoria, IL (US)

(21) Appl. No.: 15/274,864

(22) Filed: Sep. 23, 2016

(51) Int. Cl. F04B 51/00; F04B 19/22; F04B 53/14; F04B 53/10; G01L 19/00

(52) U.S. Cl. CPC F04B 51/00; F04B 19/22; G01L 19/0092; F04B 53/10; F04B 53/14

(57) ABSTRACT

A method for detecting faults in a pump includes: monitoring suction pressure and discharge pressure time domain signals, filtering the monitored suction pressure time domain signals and the discharge pressure time domain signals via a band pass filter, performing Fast Fourier Transform on the filtered suction pressure time domain signals and the discharge pressure time domain signals for conversion to suction pressure frequency domain signals and discharge pressure frequency domain signals, respectively, performing root mean square calculations on the suction pressure frequency domain signals and the discharge pressure frequency domain signals, analyzing the root mean square suction pressure frequency domain signals and the root mean square discharge pressure frequency domain signals to determine a performance index, and comparing the performance index against a predetermined cavitation threshold to determine whether cavitation exists.

### TECHNICAL FIELD

The present disclosure relates generally to pumps and, more particularly, relates to a system for detecting faults in such pumps.

### BACKGROUND

Generally, positive displacement pumps may be utilized to pump fluids in high pressure applications for a variety of industrial settings such as, but not limited to, hydraulic fracturing, cementing, coil tubing, and water jet cutting. Such pumps may include a reciprocating plunger that draws fluid into a pump chamber through a suction valve as the plunger moves in one direction and discharges the fluid from the pump chamber via a discharge valve as the plunger moves in an opposite direction. During operation, such pump components are often subjected to high working pressures such that regular monitoring may be required to track the health and performance of the pump components.

The early detection of any potential faults in such pump components is commonly desired to ensure pump efficiency and to prevent excessive downtime due to unplanned maintenance. For example, the detection of a fault, such as pump cavitation (the formation of vapor bubbles in the fluid flow inlet of the suction valve zone), at an early stage may be critical to pump health as cavitation may cause damage and accelerated wear to the pump components. While U.S. Pat. No. 6,655,922 discloses a system and method for detecting and diagnosing pump cavitation, its method and system, however, may provide cavitation detection merely according to flow and pressure data without further robust analysis and calculations.

### SUMMARY

In accordance with an aspect of the disclosure, a method for detection cavitation in a pump is provided. The method may include: monitoring suction pressure and discharge pressure time domain signals, filtering the monitored suction pressure time domain signals and the discharge pressure time domain signals via a band pass filter, performing Fast Fourier Transform on the filtered suction pressure time domain signals and the discharge pressure time domain signals for conversion to suction pressure frequency domain signals and discharge pressure frequency domain signals, respectively, performing root mean square calculations on the suction pressure frequency domain signals and the discharge pressure frequency domain signals, analyzing the root mean square suction pressure frequency domain signals and the root mean square discharge pressure frequency domain signals to determine a performance index, and comparing the performance index against a predetermined threshold to determine whether cavitation exists.

In accordance with another aspect of the disclosure, a fault detection system for a pump is provided. The fault detection system may include a suction pressure sensor operatively associated with an input of the pump. A discharge pressure sensor may be operatively associated with an output of the pump. A pump speed sensor may be configured to monitor pump speed of the pump. A processor may be in operative communication with the suction pressure sensor, the discharge pressure sensor, and the pump speed sensor. The processor may be configured to: receive suction pressure time domain signals from the suction pressure sensor, receive discharge pressure time domain signals from the discharge pressure sensor, filter the received suction pressure time domain signals and the discharge pressure time domain signals via a band pass filter, perform Fast Fourier Transform on the filtered suction pressure time domain signals and the discharge pressure time domain signals to convert to suction pressure frequency domain signals and discharge pressure frequency domain signals, respectively, perform root mean square calculations on the suction pressure frequency domain signals and the discharge pressure frequency domain signals, analyze the root mean square suction pressure frequency domain signals and the root mean square discharge pressure domain signals to determine a performance index, and compare the performance against a predetermined cavitation threshold to determine whether cavitation exists.

In accordance with yet another aspect of the disclosure, a pump is provided. The pump may include an input disposed in a housing of the pump and may be in fluid communication with a chamber via a suction valve. A suction pressure sensor may be operatively disposed proximate the input and may be configured to monitor and transmit suction pressure time domain signals associated with the input. An output may be disposed in the housing of the pump and may be in fluid communication with the chamber via discharge valve. A discharge pressure sensor may be operatively disposed proximate the output and may be configured to monitor and transmit discharge pressure time domain signals associated with the output. A processor may be in operative communication with the suction pressure sensor and the discharge pressure sensor. The processor may be configured to: receive suction pressure time domain signals from the suction pressure sensor, receive discharge pressure time domain signals from the discharge pressure sensor, filter the received suction pressure time domain signals and the discharge pressure time domain signals via a band pass filter, perform Fast Fourier Transform on the filtered suction pressure time domain signals and the discharge pressure time domain signals to convert to suction pressure frequency domain signals and discharge pressure frequency domain signals, respectively, perform root mean square calculations on the suction pressure frequency domain signals and the discharge pressure frequency domain signals, analyze the root mean square suction pressure frequency domain signals and the root mean square discharge pressure domain signals to determine a performance index, and compare the performance index against a predetermined cavitation threshold to determine whether cavitation exists.

These and other aspects and features of the present disclosure will be more readily understood upon reading the following detailed description when taken in conjunction with the accompanying drawings. Aspects of different embodiments herein described can be combined with or substituted by one another.

### BRIEF DESCRIPTION OF THE DRAWINGS

FIG. 1 is a diagrammatic, partially cross-sectioned view of an exemplary pump, in accordance with an embodiment of the present disclosure;

FIG. 2 is a schematic view of a fault detection system of the exemplary pump in FIG. 1, in accordance with an embodiment of the present disclosure;

FIG. 3 is an exemplary graph illustrating frequency response of suction pressure signals plotted as suction pressure versus frequency, in accordance with an embodiment of the present disclosure;

FIG. 4 is an exemplary graph illustrating frequency response of discharge pressure signals plotted as discharge pressure versus frequency, in accordance with an embodiment of the present disclosure;

FIG. 5 is an exemplary graph illustrating RMS of the filtered discharge pressure frequency domain signals versus the RMS of the filtered suction pressure frequency domain signals, in accordance with an embodiment of the present disclosure;

FIG. 6 is an exemplary graph illustrating RMS of the discharge pressure frequency domain signals versus pump speed, in accordance with an embodiment of the present disclosure;

FIG. 7 is an exemplary graph illustrating discharge pressure versus time along with pump speed versus time for detection results indicating a suction valve leak detection, in accordance with an embodiment of the present disclosure;

FIG. 8 is an exemplary graph illustrating the adaptive filtered discharge pressure versus time for detection results indicating a suction valve leak detection, in accordance with an embodiment of the present disclosure;

FIG. 9 is an exemplary graph illustrating the pulsation value versus time for detection results indicating a suction valve leak detection, in accordance with an embodiment of the present disclosure;

FIG. 10 is an exemplary graph illustrating discharge pressure versus time for detection results indicating a discharge valve leak detection, in accordance with an embodiment of the present disclosure;

FIG. 11 is an exemplary graph illustrating the adaptive filtered discharge pressure versus time for detection results indicating a discharge valve leak detection, in accordance with an embodiment of the present disclosure;

FIG. 12 is an exemplary graph illustrating the pulsation value versus time for detection results indicating a discharge valve leak detection, in accordance with an embodiment of the present disclosure;

FIG. 13 is a perspective view of an exemplary triplex pump, in accordance with an embodiment of the present disclosure;

FIG. 14 is an exemplary flow chart illustrating a sample sequence of steps which may be practiced in accordance with an embodiment of the present disclosure;

FIG. 15 is another exemplary flow chart illustrating another sample sequence of steps which may be practiced in accordance with an embodiment of the present disclosure;

FIG. 16 is yet another exemplary flow chart illustrating another sample sequence of steps which may be practiced in accordance with an embodiment of the present disclosure; and

FIG. 17 is a further exemplary flow chart illustrating another sample sequence of steps which may be practiced in accordance with an embodiment of the present disclosure.

### DETAILED DESCRIPTION

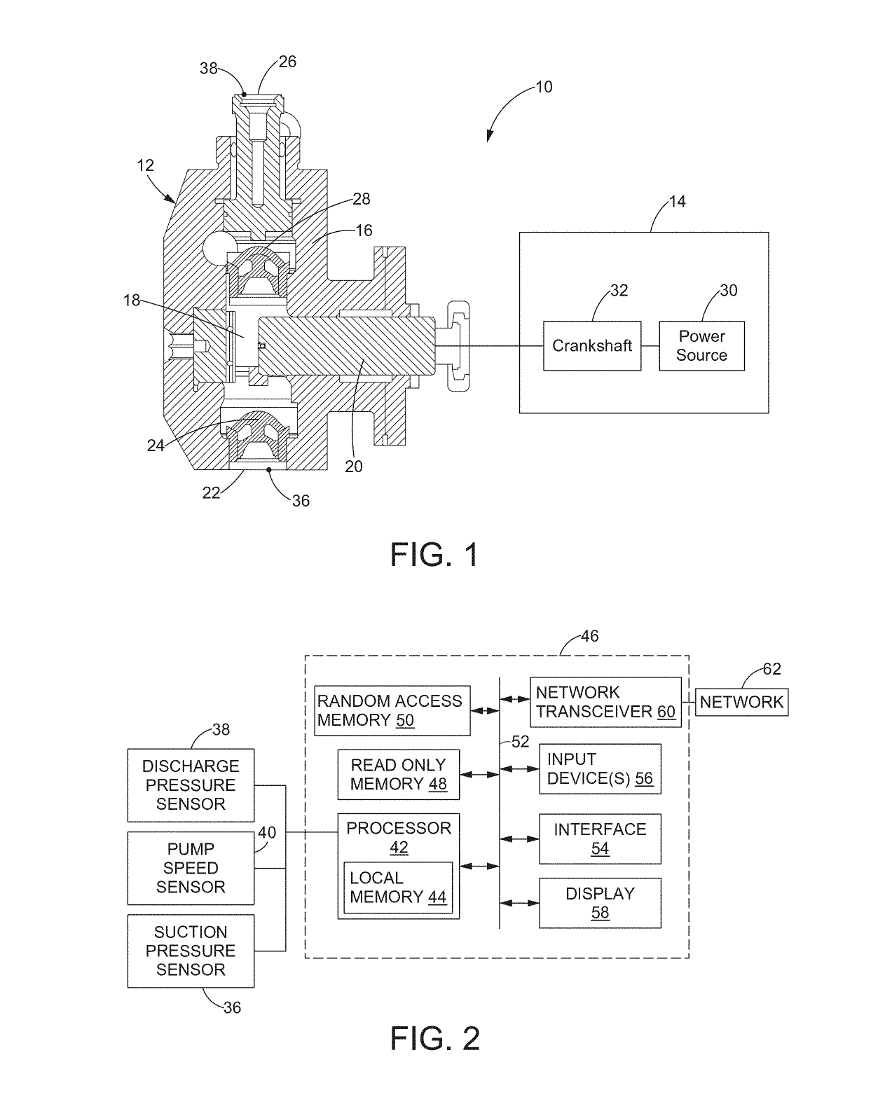

Referring now to FIG. 1, an exemplary pump constructed in accordance with the present disclosure is generally referred to by reference numeral 10. The pump 10 may be a positive displacement pump and may be utilized in various industrial settings such as, but not limited to, hydraulic fracturing, cementing, coil tubing, and water jet cutting. The pump 10 includes a fluid section 12 and a power section 14. The fluid section 12 includes a housing 16 and a chamber 18 disposed in the housing 16. The fluid section 12 of the pump 10 also includes a plunger 20 slidably disposed in the housing 16 for reciprocal motion toward and away from the chamber 18.

The fluid section 12 of the pump 10 further includes an input 22 in fluid communication with the chamber 18 via a suction valve 24. The suction valve 24 controls the flow of fluid through the input 22 into the chamber 18 as the plunger 20 reciprocates. The fluid section 12 of the pump 10 also includes an output 26 in fluid communication with the chamber 18 via a discharge valve 28. The discharge valve 28 controls the flow of fluid from the chamber 18 outwardly to the output 26 as the plunger 20 reciprocates. The reciprocating motion of the plunger 20 changes the volume of fluid in the chamber 18. In particular, when the plunger 20 reciprocates away from the chamber 18 a drop in pressure is created within the chamber 18 such that the discharge valve 28 closes and the suction valve 24 opens allowing fluid to flow through the input 22 to the chamber 18. On the other hand, when the plunger 20 reciprocates towards the chamber 18 pressure is increased such that the suction valve 24 closes and the discharge valve 28 opens forcing fluid to flow from the chamber 18 outwardly through the discharge valve 28 to the output 26.

Moreover, the pump 10 includes a power source 30 disposed in the power section 14. The power source 30 may be any type of power source such as, but not limited to, engines, gas turbine engines, generator sets, and other power sources well known in the industry. The power source 30 is operatively coupled to a crankshaft 32 via components such as a transmission and a drive shaft (both not shown). The crankshaft 32 is operatively coupled to the plunger 20 via other components such as a connected rod (not shown) such that the power source 30 drives the reciprocating motion of the plunger 20 via such operative couplings.

With reference to FIG. 2, the pump 10 is shown to also include a fault detection system 34. The fault detection system 34 includes a suction pressure sensor 36, a discharge pressure sensor 38, a pump speed sensor 40, and a processor 42. The processor 42 is operatively coupled to a local memory 44 and may be part of a computing device 46. The processor 42 may be implemented by one or more microprocessors or controllers from any desired family or manufacturer. The processor 42 may be operatively coupled with a main memory including a read-only memory 48 and a random access memory 50 via a bus 52. The random access memory 50 may be implemented by Synchronous Dynamic Random Access Memory (SDRAM), Dynamic Random Access Memory (DRAM), RAMBUS Dynamic Random Access Memory (RDRAM) and/or any other type of random access memory device. The read-only memory 48 may be implemented by a hard drive, flash memory and/or any other desired type of memory device.

The computing device 46 may also include an interface 54, which may be implemented by any type of interface standard, such as, for example, an Ethernet interface, a universal serial bus (USB), and/or a Peripheral Component Interconnect (PCI) express interface. One or more input devices 56 are operatively coupled to the interface 54. The input device(s) 56 permits a user to enter data and commands into the processor 42 and may be implemented by, for example, a keyboard, a mouse, a track-pad, a trackball, and/or a voice recognition system.

A display 58 may also be operatively coupled to the interface 54. The display 58 may be implemented by, for example, one or more display devices for associated data (e.g., a liquid crystal display, a cathode ray tube display (CRT), a monitor, etc.)

Further, the computing device 46 may include one or more network transceivers 60 for connecting to a network 62, such as the Internet, a WLAN, a LAN, a personal network, or any other network for connecting the computing device 46 to one or more other computers or network capable devices.

The computing device 46 may be used to execute machine readable instructions. For example, the computing device 46 may execute machine readable instructions to perform the exemplary steps shown in the flow charts of FIGS. 10-13, described in more detail below. In such examples, the machine readable instructions comprise a program for execution by a processor such as the processor 42 shown in example computing device 46. The program may be embodied in software stored on a tangible computer readable medium such as a CD-ROM, a floppy disk, a hard drive, a digital versatile disk (DVD), Blu-ray™ disk, or a memory associated with the processor 42, but the entire program and/or parts thereof could alternatively be executed by a device other the processor 42 and/or embodied in firmware or dedicated hardware.

The fault detection system 34 is configured to detect faults in the pump 10 such as, but not limited to, cavitation and leakage, such that the suction pressure sensor 36, the discharge pressure sensor 38, and the pump speed sensor 40 monitor and transmit pump parameters to the processor 42 for analysis and detection of such faults. With reference to FIGS. 1 and 2, the suction pressure sensor 36, the discharge pressure sensor 38, and the pump speed sensor 40 are in operative communication with the processor 42. In some embodiments, the processor 42 is located onsite and may be disposed in various locations on the pump 10 or may be located locally at other onsite areas. The suction pressure sensor 36 is configured to monitor the pressure at the input 22 and to transmit corresponding suction pressure signals, as time domain signals for example, to the processor 42. In an embodiment, the suction pressure sensor 36 is disposed in the pump 10 proximate the input 22. The discharge pressure sensor 38 is configured to monitor the pressure at the output 26 and to transmit corresponding discharge pressure signals, as time domain signals for example, to the processor 42. In an embodiment, the discharge pressure sensor 38 is disposed in the pump 10 proximate the output 26. The pump speed sensor 40 is configured to monitor the speed of the pump and to transmit a corresponding pump speed signal to the processor 42. In an embodiment, the pump speed is measured in units of rotations per minute (rpm) and may be disposed at any appropriate location in the pump 10 such as, but not limited to, the crankshaft 32 and the power source 30.

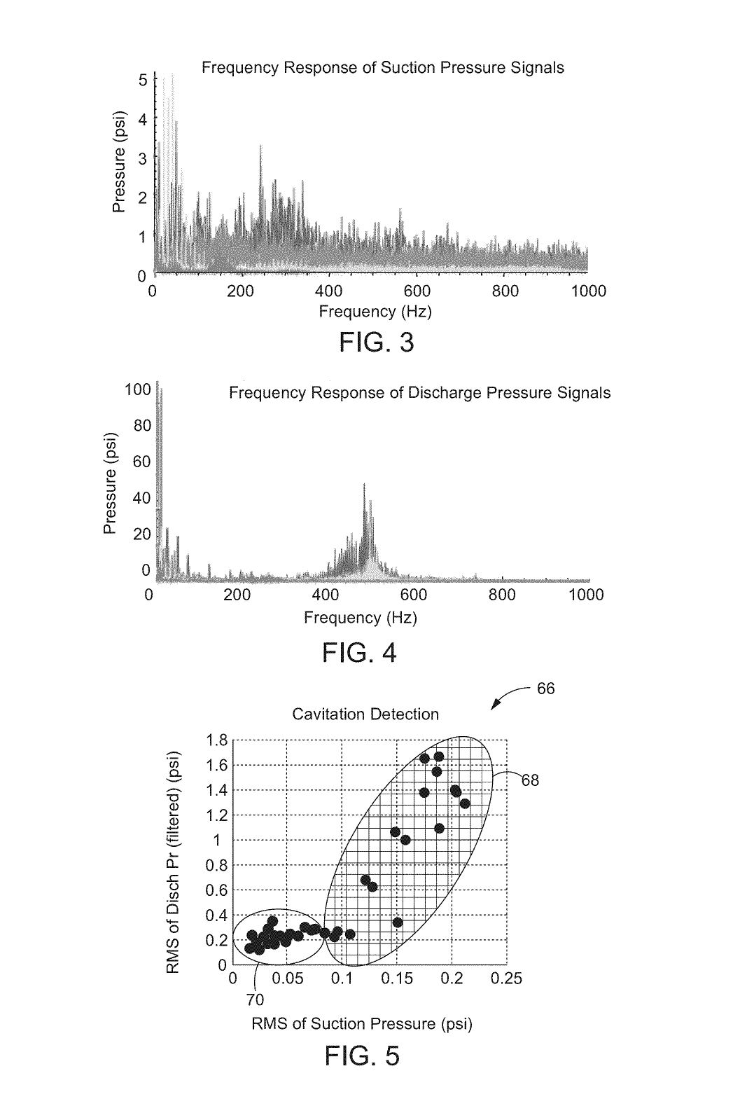

Further, the processor 42 is configured to receive the corresponding suction pressure signals and the corresponding discharge pressure signals via the suction pressure sensor 36 and the discharge pressure sensor 38, respectively, and is configured to filter the suction pressure and discharge pressure signals via a band pass filter function. The processor 42 is also configured to perform a Fast Fourier Transform (FFT) on the filtered suction pressure and discharge pressure time domain signals for conversion to suction pressure and discharge pressure frequency domain signals, respectively. As an example, FIG. 3 illustrates the frequency response of the suction pressure signals depicting the suction pressure in units of pounds per square inch (psi) versus frequency in units of Hertz (Hz). Similarly, FIG. 4 illustrates the frequency response of the discharge pressure signals depicting the discharge pressure in units of psi versus frequency in unit of Hz.

The processor 42 is further configured to perform root mean square (RMS) calculations on the suction pressure and discharge pressure frequency domain signals. With the RMS of the suction pressure frequency domain signals and the RMS of the discharge pressure frequency domain signals calculated, the processor 42 is configured to analyze these RMS calculations to determine whether there is a cavitation. For example, the processor 42 analyzes the comparison of the RMS of the discharge pressure frequency domain signals in units of psi versus the RMS of the suction discharge pressure frequency domain signals in units of psi to determine a performance index, as illustrated in exemplary cavitation detection plot 66 in FIG. 5, against a predetermined cavitation threshold to determine cavitation, as depicted in cavitation grouping 68. The cavitation grouping 68 is in contrast to healthy grouping 70, which indicates the pump 10 is operating at desired health levels. Moreover, in some embodiments, the processor 42 is configured to detect different levels of cavitation based on the predetermined cavitation thresholds such as, but not limited to, light cavitation, medium cavitation, and heavy cavitation. The processor 42 is further configured to generate a cavitation flag signal once cavitation is detected. The processor 42 may transmit the cavitation flag signal to the display 58 such that an operator can be indicated to run the pump 10 differently or stop the pump 10 entirely if heavy cavitation is detected.

Alternatively or additionally, the fault detection system 34 is configured to detect cavitation in the pump 10 by also utilizing pump speed signals received by the processor 42, along with the discharge pressure signals and the suction pressure signals. In some embodiments, the processor 42 is configured to determine a performance ratio value, which is defined as the average ratio of the discharge pressure signals versus the suction pressure signals multiplied by the pump speed signals, and compare and analyze the performance ratio value against a predetermined cavitation ratio value to determine whether cavitation exists. If it is determined that the performance ratio value exceeds the predetermined cavitation ratio value, then there is a cavitation. Once it is determined that a cavitation exists, the processor 42 may generate and transmit the cavitation flag signal to the display 58.

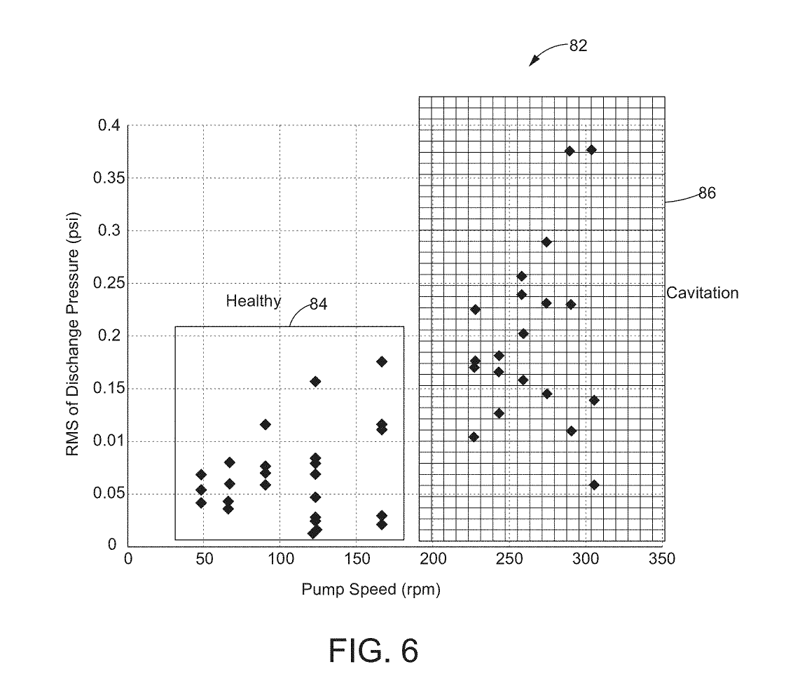

In another embodiment, the processor 42 is configured to analyze and compare the RMS of the discharge pressure frequency domain signals and the pump speed signals to determine whether there is a cavitation. As a visual example illustrated in FIG. 6, the RMS discharge pressure versus pump speed plot 82 depicts the processor 42 analyzing the plot points of the RMS of the discharge pressure frequency domain signals in units of psi versus the pump speed signals in units of rpm to determine a performance discharge versus speed value. Moreover, the processor 42 compares the performance discharge versus speed value against a predetermined cavitation discharge versus speed threshold to determine cavitation. For example, discharge versus speed value plot points within a healthy array 84 indicate a healthy pump 10 and plot points within a cavitation array 86, depicting the predetermined cavitation discharge versus speed threshold, indicate cavitation exists. Once it is determined that a cavitation exists, the processor 42 may generate and transmit the cavitation flag signal to the display 58.

Moreover, the fault detection system 34 detects leakage faults when the pump speed is changing. The processor 42 is configured to filter the discharge pressure time domain signals received from the discharge pressure sensor 38 via a fixed band pass filter function to eliminate the direct current (DC) value from the signals. After being filter by the fixed band pass filter, the processor 42 is further configured to filter the signals with an adaptive band pass filter including adaptive filter coefficients, which the processor 42 determines based on the pump speed.

The adaptive band pass filter is a second order transfer function and may be represented by the following equation:

H_{ABP}(z)=((1−α)/2)*((1−z⁻²)/(1−β(1+α)z⁻¹+αz⁻²))

Where α defines the bandwidth and is a predefined constant such that B_{w}=cos⁻¹(2α/(1+α²)) is the 3 db bandwidth; and β defines the center frequency ω₀=cos⁻¹ (β). In this application, β=cos (2πN/60Tₛ), where N is the pump speed in rpm and Tₛ is the system sample time in seconds. As such, when the pump speed changes, the center frequency of the adaptive band pass filter changes to filter out other signals and produces the discharge pressure at the leak frequency with pump speed over 60, as an example.

With the discharge pressure at leak frequency obtained, the processor 42 is configured to determine a pulsation value, which is defined as the ratio of peak-to-peak discharge pressure and the average discharge pressure. The processor 42 is configured to compare the pulsation value against a predetermined pulsation threshold. If the pulsation value is greater than the predetermined pulsation threshold for more than a predetermined debounce time, then a leakage exists and the processor 42 generates a leakage flag signal and transmits the leakage flag signal to the display 58. If the pulsation value is less than the predetermined pulsation threshold, then leakage does not exist.

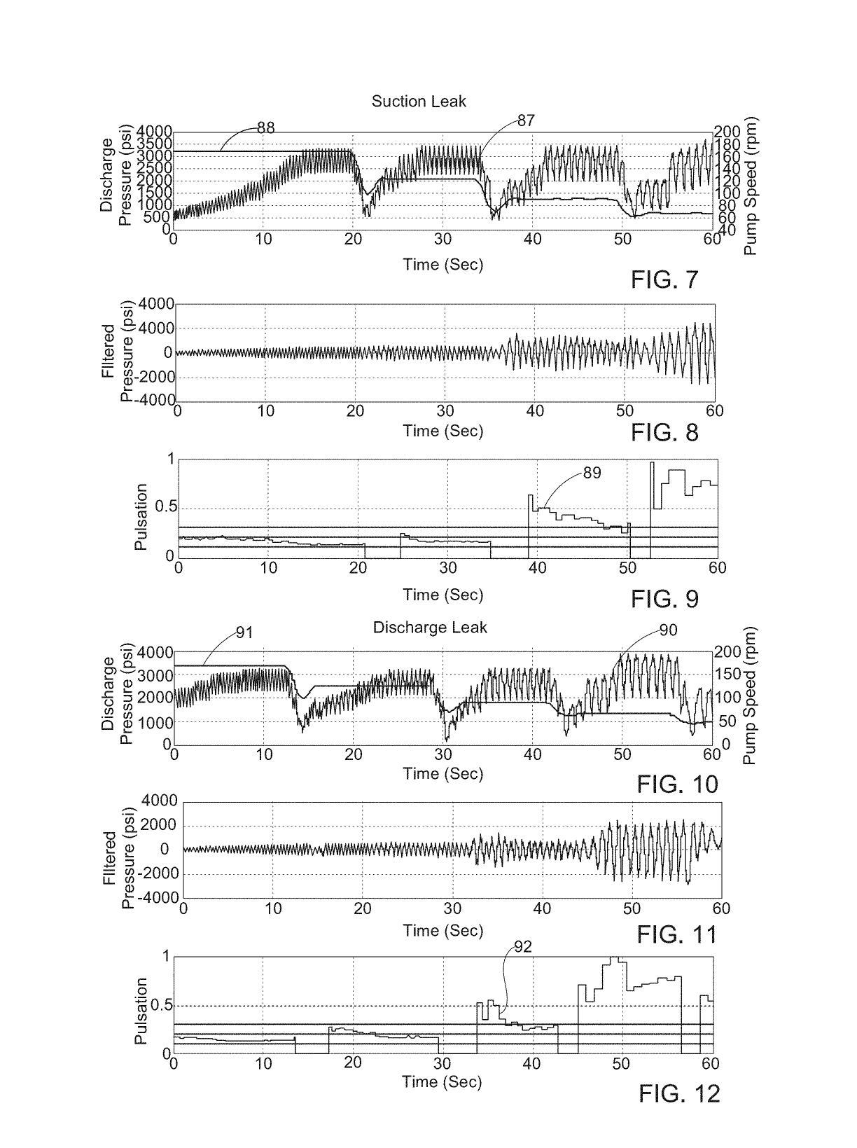

With reference to FIGS. 7-9, an exemplary suction valve leakage detection is illustrated. For example, as depicted in FIG. 7, the discharge pressure in units of psi versus time in units of seconds is depicted as a first plot curve 87. FIG. 7 is overlaid with a second plot curve 88 of pump speed in units of rpm versus time in units of seconds to illustrate the change in discharge pressure as the pump speed changes. Moreover, FIG. 8 illustrates the discharge pressure in units of psi versus time in units of seconds after the adaptive band pass filter has filtered the discharge pressure depicted in FIG. 7. FIG. 9 illustrates the pulsation value, plotted as a unitless ratio, versus time in units of seconds to depict, along a third plot curve 89, the leakage detection, which can be compared with the change in pump speed depicted along the second plot curve 88 in FIG. 7.

Referring to FIGS. 10-12, as a further example, an exemplary discharge valve leakage detection is similarly illustrated. For example, as depicted in FIG. 10, the discharge pressure in units of psi versus time in units of seconds is depicted as a fourth plot curve 90. FIG. 10 is overlaid with a fifth plot curve 91 of pump speed in units of rpm versus time in units of seconds to illustrate the change in discharge pressure as the pump speed changes. Moreover, FIG. 11 illustrates the discharge pressure in units of psi versus time in units of seconds after the adaptive band filter has filtered the discharge pressure depicted in FIG. 10. FIG. 12 illustrates the pulsation value, plotted as a unitless ratio, versus time in units of seconds to depict, along a sixth plot curve 92, the leakage detection, which can be compared with the change in pump speed depicted along the fifth plot curve 91 in FIG. 10.

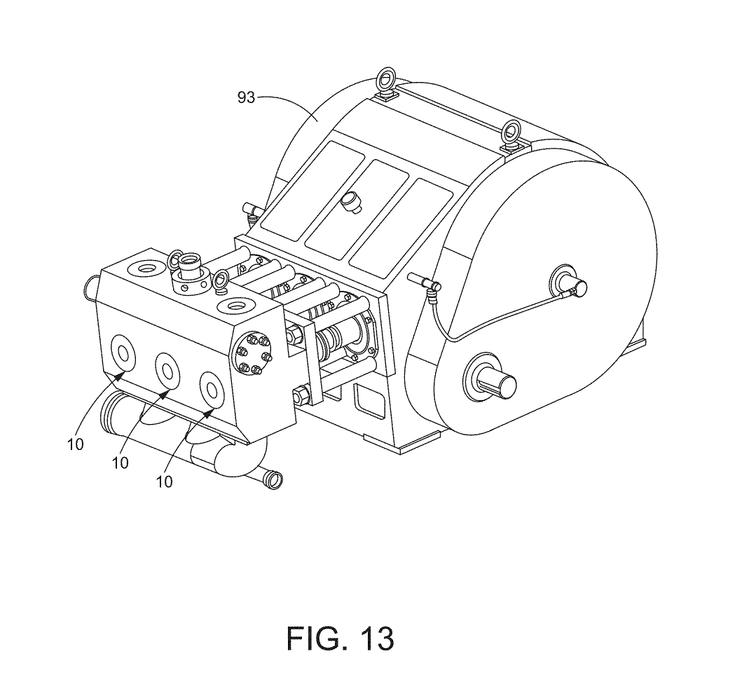

While the fluid section 12 of the pump 10 has thus far been described as a single-chambered pump to facilitate clarity in explanation, it should be understood that two or more fluid sections substantially identical to that of the pump 10 may be appropriately interconnected to form a triplex pump 93, as exemplarily illustrated in FIG. 13, or other multi-cylinder pumps without departing from the scope of this disclosure.

### INDUSTRIAL APPLICABILITY

In general, the present disclosure may find applicability with positive displacement pumps utilized in high pressure applications for any number of industrial settings such as, but not limited to, hydraulic fracturing, cementing, coil tubing, and water jet cutting. As a non-limiting example, the pump 10 may be a fracturing rig pump operating at a wellbore site. By utilizing the systems and methods disclosed herein, the fault detection system 34 can be employed to detect faults in the pump 10 such as, but not limited to, cavitation and leakage faults in a manner that may provide robust fault detection, which may result in less unplanned downtime due to maintenance and, in turn, may lead to increased pump life.

For example, with the pump 10 utilized at a wellbore site, the processor 42 of the fault detection system 34 may be disposed on the pump 10 or located in the nearby vicinity of the pump 10 at the site. The close proximity of the processor 42 to the pump 10 may facilitate faster fault detection as the data signals are transmitted from the suction pressure sensor 36, the discharge pressure sensor 38, and the pump speed sensor 40 to the onsite processor 42, which may provide real-time fault detection, as opposed to offsite, back-office diagnostics that sometimes involve delayed analysis. Moreover, the processor 42 of the fault detection system 34 may provide complex data transformations, such as FFT, for robust diagnostics in fault detection.

Further, by utilizing data monitored from the suction pressure sensor 36, the discharge pressure sensor 38, and the pump speed sensor 40, in various combinations, the processor 42 of the fault detection system 34 may more accurately detect cavitation in contrast to systems that merely analyze discharge pressure data for detection, which may misidentify a cavitation as a result of the cavitation and the noise frequency being in the same range.

Additionally, the processor 42 of the fault detection system 34 may provide robust fault detection by applying the adaptive band pass filter to adjust the band pass frequency for fault detection even as the pump speed varies during operation. This may be contrasted with systems that merely monitor one frequency, which may misdiagnose a fault when the pump speed changes during operation.

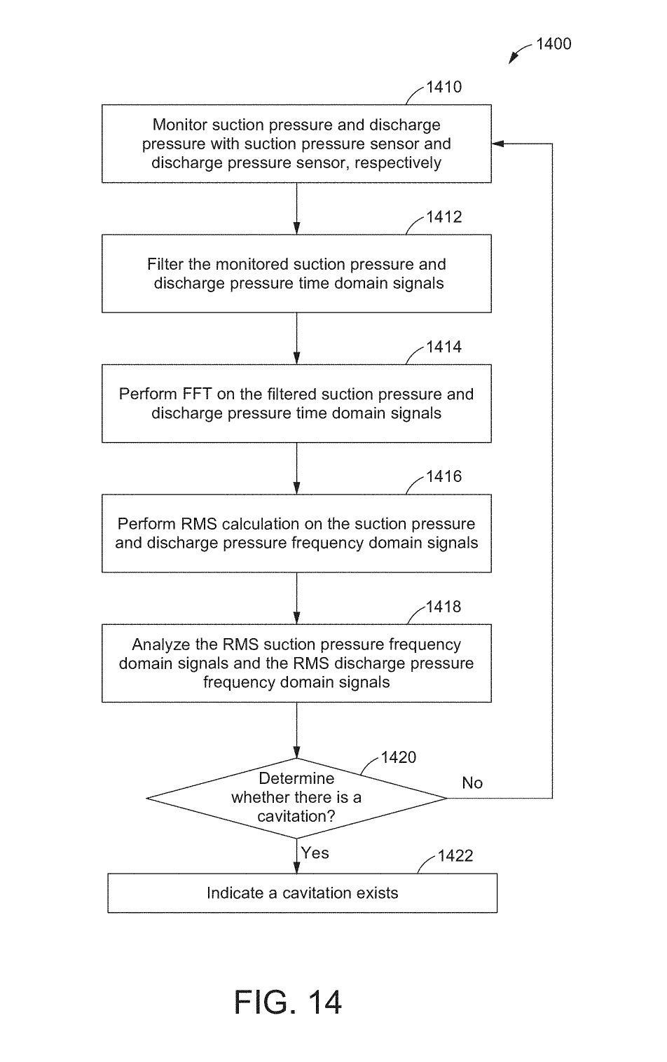

FIG. 14 illustrates a flow chart 1400 of a sample sequence of blocks which may be performed to detect a fault, such as a cavitation, in the pump 10. Block 1410 illustrates the step of monitoring the suction pressure of the pump 10 with the suction pressure sensor 36 and monitoring the discharge pressure of the pump 10 with the discharge pressure sensor 38. The suction pressure sensor 36 and the discharge pressure sensor 38 transmit suction pressure time domain signals and discharge pressure time domain signals, respectively, to the processor 42. As illustrated in block 1412, the processor 42 receives the suction pressure time domain signals and the discharge pressure time domain signals and filters the signals via a band pass filter. Block 1414 illustrates the step of the processor 42 performing FFT on the filtered suction pressure time domain signals and the filtered discharge pressure time domain signals to convert the filtered signals to suction pressure frequency domain signals and discharge pressure frequency domain signals, respectively. In another step, as illustrated in block 1416, the processor 42 performs RMS calculations on the suction pressure frequency domain signals and the discharge pressure frequency domain signals.

As illustrated in block 1418, the processor 42 compares and analyzes the RMS suction pressure frequency domain signals and the RMS discharge pressure frequency domain signals. The processor 42 then analyzes the RMS of the discharge pressure frequency domain signals versus the RMS of the suction discharge pressure frequency domain signals to determine a performance index and compares the performance index against a predetermined cavitation threshold to determine whether cavitation exists, as illustrated in decision block 1420. If the processor 42 determines that cavitation does not exist, then the suction pressure sensor 36 and the discharge pressure sensor 38 continue monitoring and transmitting respective signals to the processor 42, as illustrated by the return to block 1410. If the processor 42, on the other hand, determines that cavitation does exist, the processor 42 generates a cavitation flag signal and transmits the cavitation flag signal to the display 58 to indicate cavitation exists, as illustrated in block 1422.

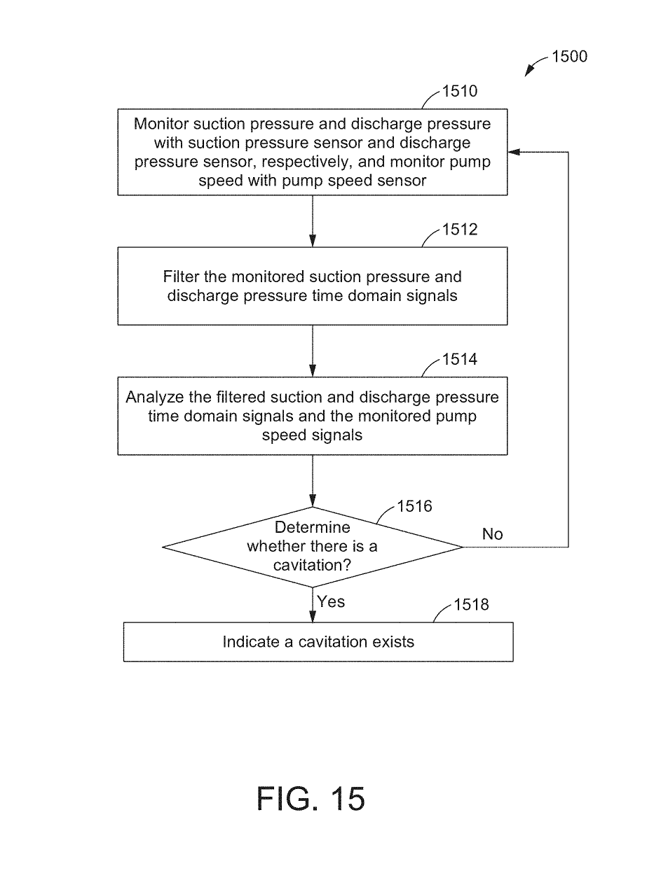

FIG. 15 illustrates a flow chart 1500 of another sample sequence of blocks which may be performed, alternatively or additionally, to detect a cavitation, in the pump 10. Block 1510 illustrates the step of monitoring the suction pressure of the pump 10 with the suction pressure sensor 36, monitoring the discharge pressure of the pump 10 with the discharge pressure sensor 38, and monitoring the pump speed with the pump speed sensor 40. The suction pressure sensor 36 and the discharge pressure sensor 38 transmit suction pressure time domain signals and discharge pressure time domain signals, respectively, to the processor 42. The pump speed sensor 40 transmits pump speed signals to the processor 42. As illustrated in block 1512, the processor 42 receives the suction pressure time domain signals and the discharge pressure time domain signals and filters the signals via a band pass filter. Block 1514 illustrates the step of the processor 42 analyzing the filtered suction pressure and discharge pressure time domain signals and the pump speed signals to determine a performance ratio value, defined as the average ratio of the discharge pressure signals versus the suction pressure signals multiplied by the pump speed signals. The processor 42 further analyzes and compares the performance ratio value against a predetermined ratio value to determine whether cavitation exists, as illustrated in decision block 1516. If the processor 42 determines that cavitation does not exist, then the suction pressure sensor 36, the discharge pressure sensor 38, and the pump speed sensor 40 continue monitoring and transmitting respective signals to the processor 42, as illustrated by the return to block 1510. If the processor 42, on the other hand, determines that cavitation does exists, the processor 42 generates a cavitation flag signals and transmits the cavitation flag signal to the display 58, as illustrated in block 1518.

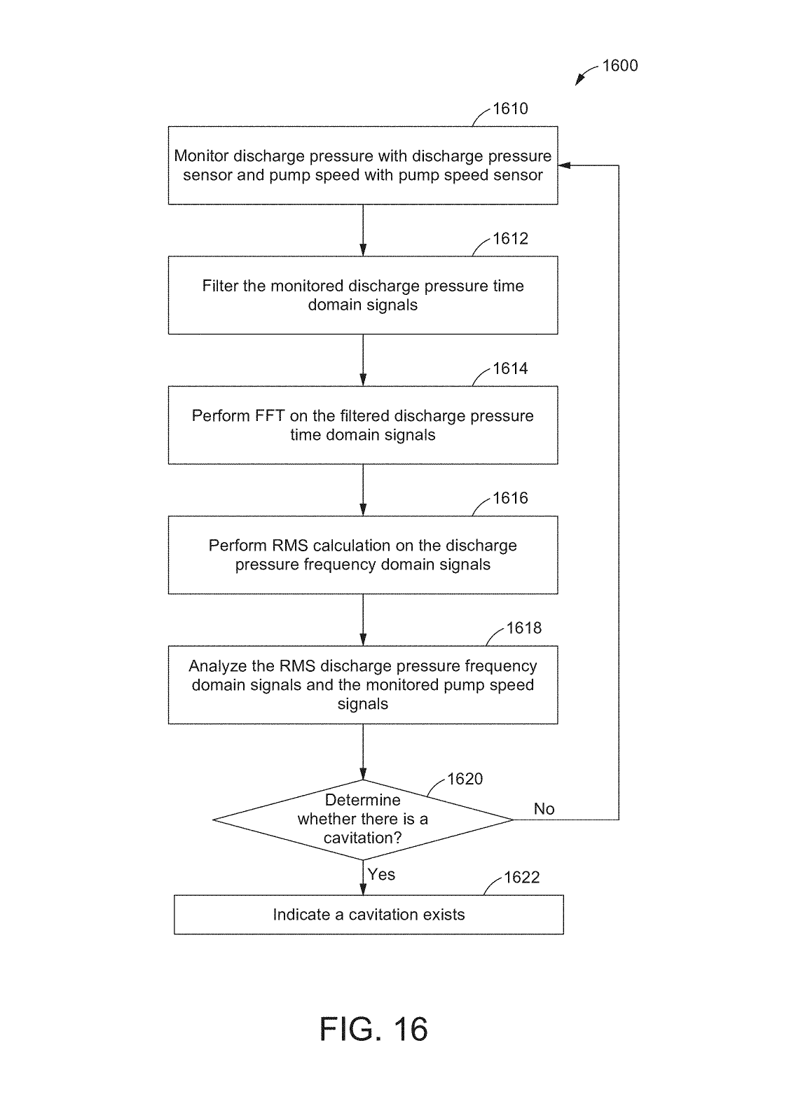

FIG. 16 illustrates a flow chart 1600 of still another sample sequence of blocks which may be performed, alternatively or additionally, to detect a cavitation, in the pump 10. Block 1610 illustrates the step of monitoring the discharge pressure of the pump 10 with the discharge pressure sensor 38 and monitoring the pump speed with the pump speed sensor 40. The discharge pressure sensor 38 transmits discharge pressure time domain signals to the processor 42 and the pump speed sensor 40 transmits pump speed signals to the processor 42. As illustrated in block 1612, the processor 42 the discharge pressure time domain signals and filters the signals via a band pass filter. Block 1614 illustrates the step of the processor 42 performing FFT on the filtered discharge pressure time domain signals to convert the filtered signals to discharge pressure frequency domain signals. In another step, as illustrated in block 1616, the processor 42 performs RMS calculations on the discharge pressure frequency domain signals.

As illustrated in block 1618, the processor 42 analyzes the RMS of the discharge pressure frequency domain signals and the pump speed signals to determine the performance discharge versus speed value. The processor 42 further analyzes and compares the performance discharge versus speed value against a predetermined cavitation discharge versus speed value to determine whether cavitation exists, as illustrated in decision block 1620. If the processor 42 determines that cavitation does not exist, then the discharge pressure sensor 38 and the pump speed sensor 40 continue monitoring and transmitting respective signals to the processor 42, as illustrated by the return to block 1610. If the processor 42, on the other hand, determines that cavitation does exist, the processor 42 generates a cavitation flag signal and transmits the cavitation flag signal to the display 58, as illustrated in block 1622.

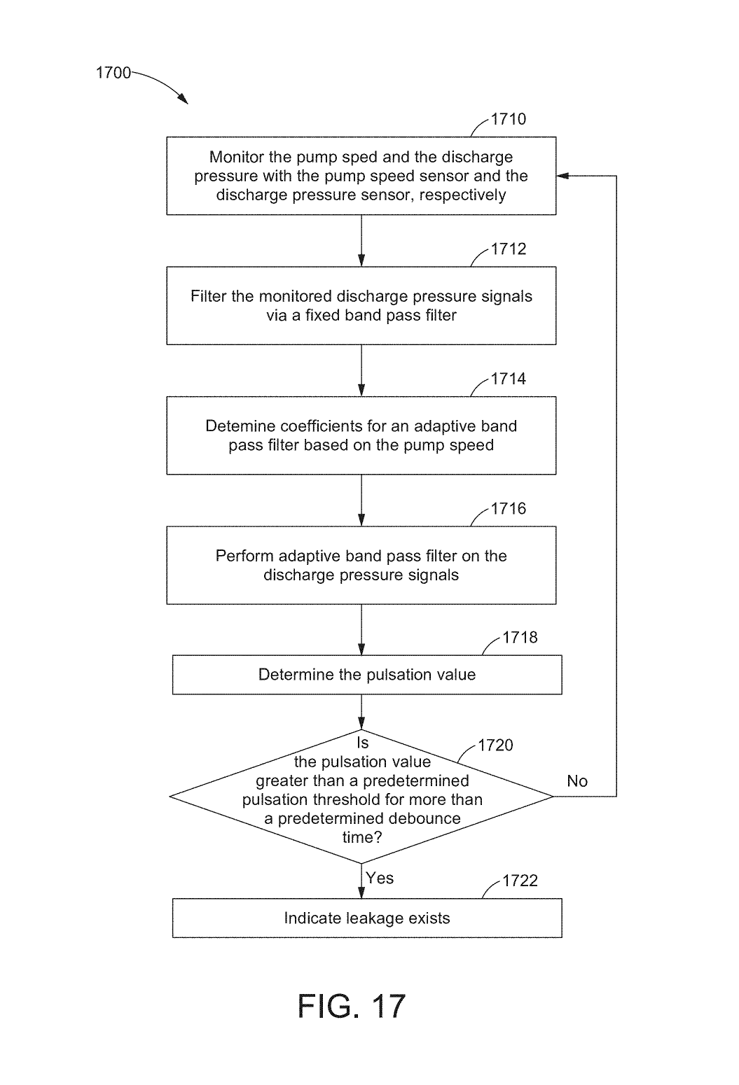

FIG. 17 illustrates a flow chart 1700 of a sample sequence of blocks which may be performed to detect another fault, such as a leakage, in the pump 10. Block 1710 illustrates the step of monitoring the pump speed signals from the pump speed sensor 40 and the discharge pressure signals from the discharge pressure sensor 38. As illustrated in block 1712, the processor 42 filters the discharge pressure signals received from the discharge pressure sensor 38 via a fixed band pass filter function. As illustrated in block 1714, the processor 42 determines the coefficients for an adaptive band pass filter based on the pump speed signals and, as illustrated in block 1716, the processor 42 further filters the discharge pressure signals via the adaptive band pass filter to determine the discharge pressure at the leak frequency.

As illustrated in block 1718, the processor 42 determines the pulsation value for comparison against the predetermined pulsation threshold. At decision block 1720, the processor 42 determines whether the pulsation value is greater than the predetermined pulsation threshold for more than a predetermined debounce time. If the processor 42 determines that the pulsation value is greater than the predetermined pulsation threshold, then a leakage exists and the processor 42 generates the leakage flag signal and transmits the leakage flag signal to the display 58, as illustrated in block 1722. If the processor 42 determines that the pulsation value is less than the predetermined pulsation threshold, then the processor 42 continues receiving the pump speed signals from the pump speed sensor 40 and the discharge pressure signals from the discharge pressure sensor 38 for filtering, as illustrated by the return to block 1710.

What is claimed is:

1. A method for detecting cavitation in a pump, the method comprising:
monitoring suction pressure time domain signals of the pump;
monitoring discharge pressure time domain signals of the pump;
filtering the monitored suction pressure time domain signals and the discharge pressure time domain signals via a band pass filter;
performing Fast Fourier Transform on the filtered suction pressure time domain signals and the discharge pressure time domain signals for conversion to suction pressure frequency domain signals and discharge pressure frequency domain signals, respectively;
performing root mean square calculations on the suction pressure frequency domain signals and the discharge pressure frequency domain signals;
analyzing the root mean square suction pressure frequency domain signals and the root mean square discharge pressure frequency domain signals to determine a performance index; and
comparing the performance index against a predetermined cavitation threshold to determine whether cavitation exists.

2. The method of claim 1, further comprising indicating cavitation exists, via a display, when cavitation is determined to exist.

3. The method of claim 1, further comprising monitoring pump speed signals of the pump.

4. The method of claim 3, further comprising determining a performance ratio value by calculating an average ratio of the monitored discharge pressure time domain signals versus the monitored suction pressure time domain signals and multiplying by the monitored pump speed signals.

5. The method of claim 4, further comprising comparing the performance ratio value against a predetermined cavitation ratio value to determine whether cavitation exists.

6. The method of claim 3, further comprising analyzing the root mean square discharge pressure frequency domain signals and the monitored pump speed signals to determine a performance discharge versus speed value.

7. The method of claim 6, further comprising comparing the performance discharge versus speed value against a predetermined cavitation discharge versus speed threshold to determine whether cavitation exists.

8. A fault detection system for a pump, the fault detection system comprising:
a suction pressure sensor operatively associated with an input of the pump;
a discharge pressure sensor operatively associated with an output of the pump;
a pump speed sensor configured to monitor pump speed of the pump; and
a processor in operative communication with the suction pressure sensor, the discharge pressure sensor, and the pump speed sensor, the processor configured to:
receive suction pressure time domain signals from the suction pressure sensor;
receive discharge pressure time domain signals from the discharge pressure sensor;
filter the received suction pressure time domain signals and the discharge pressure time domain signals via a band pass filter;
perform Fast Fourier Transform on the filtered suction pressure time domain signals and the discharge pressure time domain signals to convert to suction pressure frequency domain signals and discharge pressure frequency domain signals, respectively;
perform root mean square calculations on the suction pressure frequency domain signals and the discharge pressure frequency domain signals;
analyze the root mean square suction pressure frequency domain signals and the root mean square discharge pressure frequency domain signals to determine a performance index; and
compare the performance index against a predetermined cavitation threshold to determine whether cavitation exists.

9. The fault detection system of claim 8, wherein the processor is further configured to receive pump speed signals from the pump speed sensor and determine a performance ratio value by calculating an average ratio of the received discharge pressure time domain signals versus the received suction pressure time domain signals and multiplying by the received pump speed signals.

10. The fault detection system of claim 9, wherein the processor is further configured to compare the performance ratio value against a predetermined cavitation ratio value to determine whether cavitation exists.

11. The fault detection system of claim 8, wherein the processor is further configured to analyze the root mean square discharge pressure frequency domain signals and the received pump speed signals to determine a performance discharge versus speed value.

12. The fault detection system of claim 11, wherein the processor is further configured to compare the performance discharge versus speed value against a predetermined cavitation discharge versus speed threshold to determine whether cavitation exists.

13. The fault detection system of claim 8, wherein the processor is further configured to filter the received discharge pressure signals via a fixed band pass filter, determine coefficients for an adaptive band pass filter based on the received pump speed signals, filter the fixed band pass filtered discharge pressure signals via the adaptive band pass filter, determine a pulsation value, and compare the pulsation value against a pulsation threshold to determine whether a leakage exists.

14. A pump, comprising:
an input disposed in a housing of the pump and in fluid communication with a chamber via a suction valve;
a suction pressure sensor operatively disposed proximate the input and configured to monitor and transmit suction pressure time domain signals associated with the input;
an output disposed in the housing of the pump and in fluid communication with the chamber via a discharge valve;
a discharge pressure sensor operatively disposed proximate the output and configured to monitor and transmit discharge pressure time domain signals associated with the output;
a processor in operative communication with the suction pressure sensor and the discharge pressure sensor, the processor configured to:
receive suction pressure time domain signals from the suction pressure sensor;
receive discharge pressure time domain signals from the discharge pressure sensor;
filter the received suction pressure time domain signals and the discharge pressure time domain signals via a band pass filter;
perform Fast Fourier Transform on the filtered suction pressure time domain signals and the discharge pressure time domain signals to convert to suction pressure frequency domain signals and discharge pressure frequency domain signals, respectively;
perform root mean square calculations on the suction pressure frequency domain signals and the discharge pressure frequency domain signals;
analyze the root mean square suction pressure frequency domain signals and the root mean square discharge pressure frequency domain signals to determine a performance index; and
compare the performance index against a predetermined cavitation threshold to determine whether cavitation exists.

15. The pump of claim 14, further comprising a pump speed sensor configured to monitor pump speed of the pump.

16. The pump of claim 15, wherein the processor is in operative communication with the pump speed sensor and is further configured to receive pump speed signals from the pump speed sensor and determine a performance ratio value by calculating an average ratio of the received discharge pressure time domain signals versus the received suction pressure time domain signals and multiplying by the received pump speed signals.

17. The pump of claim 16, wherein the processor is further configured to compare the performance ratio value against a predetermine cavitation ratio value to determine whether cavitation exists.

18. The pump of claim 15, wherein the processor is further configured to analyze the root mean square discharge pressure frequency domain signals and the received pump speed signals to determine a performance discharge versus speed value.

19. The pump of claim 18, wherein the processor is further configured to compare the performance discharge versus speed value against a predetermined cavitation discharge versus speed threshold to determine whether cavitation exists.

20. The pump of claim 15, wherein the processor is further configured to filter the received discharge pressure signals via a fixed band pass filter, determine coefficients for an adaptive band pass filter based on the received pump speed signals, filter the fixed band pass filtered discharge pressure signals via the adaptive band pass filter, determine a pulsation value, and compare the pulsation value against a pulsation threshold to determine whether a leakage exists.
